(19) United States
(12) Patent Application Publication
(10) Pub. No.: US 2013/0335944 A1
(43) Pub. Date: Dec. 19, 2013

(54) COOL TUBE (TM) LED LIGHTING

(71) Applicants: Robert D. Battis, Mercerville, NJ (US); Wayne Armstrong, Placitas, NM (US)

(72) Inventors: Robert D. Battis, Mercerville, NJ (US); Wayne Armstrong, Placitas, NM (US)

(21) Appl. No.: 13/916,846

(22) Filed: Jun. 13, 2013

Related U.S. Application Data
(60) Provisional application No. 61/659,143, filed on Jun. 13, 2012.

(51) Int. Cl. F21K 99/00

(52) U.S. Cl. CPC F21K 9/17
USPC 362/20; 362/218

(57) ABSTRACT

Provided is a brilliant Humiliation light fixture using high efficiency white LEDs in a strip design that can replace many conventional single or multiple tube fluorescent lighting fixtures. This LED lighting fixture provides benefits in lower installation cost, lower cost of ownership, lower room heating, higher illumination availability, higher efficiency, elimination of faculae, flexibility in re-layout lighting and avoidance of hazard waste. The lighting fixture are not to be confused with “LED fluorescent tubes” which is a name common in the industry to describe a fluorescence tube shape containing a linear array of LEDs that is designed to replace individual fluorescent tubes.

### CROSS REFERENCE TO RELATED APPLICATIONS

This application is related to and claims priority from U.S. Provisional Patent Application No. 61/659,143 filed on Jun. 13, 2012, by Robert Battis, et al., titled “ECOEarth™—LED Cool Tube”, which is incorporated herein by reference in its entirety.

### FIELD OF THE INVENTION

This invention generally relates to lighting, and more particularly to a brilliant illumination concept using high efficiency white light emitting diodes (LEDs) in a unique strip design that can replace many conventional single or multiple tube fluorescent lighting fixtures.

### BACKGROUND OF THE INVENTION

Conventional fluorescent lighting fixtures, such as those frequently used in industrial, governmental, hospital and office settings, provide useful lighting but include several disadvantages. For example, disadvantages of conventional fluorescent lighting include: limited lifespan of the fluorescent lighting tubes, relatively high maintenance cost due to need to replace fluorescent lighting tubes, high discomfort level due to drab light and bulb flicker, use of hazardous material in the fluorescent lighting tubes—such as mercury—which must be disposed in a hazardous material landfill, and other problems. As a lifespan data point, fluorescent lighting tubes have been rated at 750-1000 hours of life compared to LEDs which have been rated at 70,000 or more hours of useful life. See, for example, http://www.lumec.com/newsletter/architect_{—}06-08/led.htm for an exemplary industrial specification.

Conventional fluorescent lighting tubes and their fixtures are also difficult to seal or waterproof, especially consideration that the fixtures tend to allow for access to the fluorescent lighting tubes, such as for replacement. This relative sealing difficulty renders the conventional fluorescent lighting fixture unsuitable for environments which are submerged, moist, and/or explosive, such as in a coal mine.

LEDs are now increasingly able to deliver white, blue-white and near-white light, and do not include many of the disadvantages of fluorescent lighting tubes. However, LEDs do produce a significant amount of heat. LEDs are currently packaged as clusters in a small envelop to replace individual incandescent bulbs or in small linear arrays designed as small direct projection radiation sites within a tube as a replacement for a single fluorescent tube. These “LED” fluorescent tubes require the same fixture style and most of the same components as the standard fluorescent tube fixture, but without the classic ballast, as illustrated in FIG. 6.

It is thus desirable to provide for an LED-based fluorescent light tube replacement fixture incorporating an efficient heat sink.

It is also desirable to provide an LED lighting fixture amenable to overcome the disadvantages of conventional fluorescent tube lighting fixtures.

### SUMMARY OF THE INVENTION

An aspect of the invention provides a brilliant illumination light fixture using high efficiency white LEDs in a strip design that can replace many conventional single or multiple tube fluorescent lighting fixtures. This LED lighting fixture provides benefits in lower installation cost, lower cost of ownership, lower room heating, higher illumination availability, higher efficiency, elimination of faculae, flexibility in re-layout lighting and avoidance of hazard waste. These LED lighting fixtures are not to be confused with “LED fluorescent tubes” which lighting is a name common in the industry to describe a fluorescence tube shape containing a linear array of LEDs that is designed to replace individual fluorescent tubes. In an embodiment, the lighting fixture is mountable in the place of a standard conventional fluorescent lighting fixture.

In another aspect of the invention, this type of LED lighting fixture can be sealed making it attractive for use in wet or potentially explosive environments such as on boats, grain elevators and mines. In these special environments, the LED fixtures may be operated from low voltage power lines, further reducing environmental hazards.

An aspect of the invention provides a lighting fixture including an extruded core having a front panel light pipe and a plurality of LEDs arranged in one or more lines on the light pipe and connected to a power supply. A light diffuser is also attached to the core at a joint seal, which also includes an integrated heat sink. In embodiments of the invention the extruded core is aluminum and end plates are also attached to the core, also at a joint seal.

In an aspect of the invention, light diffuser and end plates are attached to the core at a joint seal providing a watertight seal between the light diffuser and the core. In an embodiment of the invention, the light diffuser includes an external surface treatment, such as a prism light guiding plate in combination with an optical film or micro lens embossing, or the like.

Another aspect of the invention provides that the LEDs are coupled to the front panel light pipe by means of an internal light pipe. In an embodiment, the light pipe is an integral part of the light diffuser.

In another aspect of the invention, the lighting fixture also includes a backup battery power supply in communication with the LEDs. In an embodiment of the invention the LEDs are in communication with a control circuit.

Another aspect of the invention provides that the light output intensity produced by the lighting fixture in operation can be the same as, more than, or less than the light output intensity produced during operation of a conventional fluorescent lighting fixture.

Another aspect provides that the wavelength of the tight produced in operation of the lighting fixture is white. In yet another aspect of the invention, the lighting fixture also includes as color adjustment control in communication with the LEDs and operation the wavelength and intensity of light emitted can be changed using the color adjustment control.

In another aspect of the invention the lighting fixture's power supply is a battery and the lighting fixture further includes a handle designed to allow it to be carried by a person. Embodiments are provided in which the lighting fixture is designed for water submersion or underwater illumination, or as a backlight illumination source for an advertising panel.

### BRIEF DESCRIPTION OF THE DRAWINGS

Embodiments will be described with reference to the following drawing figures, in which like numerals represent like items throughout the figures, and in which:

FIG. 1 is an end view cross section of a lighting fixture that is useful for understanding the present invention.

FIG. 2 is a side view of a lighting fixture that is useful for understanding the present invention.

FIG. 3 is a side view of a lighting fixture with covers in place that is useful for understanding the present invention.

FIG. 4 is a plan view of linear LED array details that is useful for understanding the present invention.

FIG. 5 are end views of alternative lighting fixture core configurations that is useful for understanding the present invention.

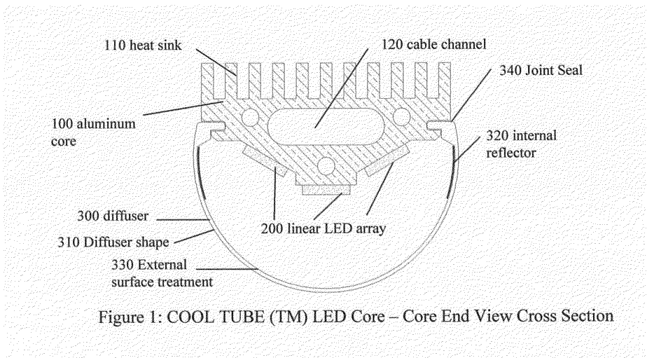

FIG. 1 is as profile view of a conventional prior art fluorescent lighting fixture.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced, without these specific details. In some instances, well-known features may he omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

An embodiment of the present invention advantageously provides for a lighting fixture to replace conventional fluorescent bulb lighting fixtures which offer greatly increased lifespan, multiple power sources, emergency lighting via a battery backup, easily replaceable electronics, reduced operating and ownership costs, reduced heat output, greatly reduced electrical power cost to operate for same luminous flux, increased comfort level, no or little hazardous material, no light or dark spots, more consistent light quality over time, and simplified relocation over conventional fluorescent lighting fixtures.

An embodiment of the present invention advantageously provides for integral and automatic battery backup in the event primary power is lost.

An embodiment of the present invention also provides for a sealed, battery powered, LED based mobile lighting fixture that can be used in wet, moist or potentially explosive locations.

In one embodiment as illustrated in FIG. 1, COOL TUBE™ LED technology includes a light fixture module consisting of an extruded aluminum core 100 containing an integral heat sink 110, multiple linear arrays of LEDs 200, with an attached light diffuser 300. The light diffuser shape 310, internal surface treatment 320 and external surface treatment 330 are optimized to maximize light transfer efficiency from the LED arrays to the tube's exit radiation cone. Diffuser surface treatments include, but are not limited to, mico lens embossing and prism light guiding plate in combination with an optical film (“TrT”) as described in U.S. Patent Application Publication Serial No. 2006/0268418 entitled Method of Making and Using Optical Films, to Kim (U.S. patent application Ser. No. 11/417,172). The diffuser 300 is sealed 340 to the core 100. An extruded aluminum core is preferred over a core manufactured using other processes, such as aluminum casting, because of the efficiency of its integral heat sink 110, as well as other advantageous qualities. It is alternatively envisioned that other materials may be found usable in place of aluminum.

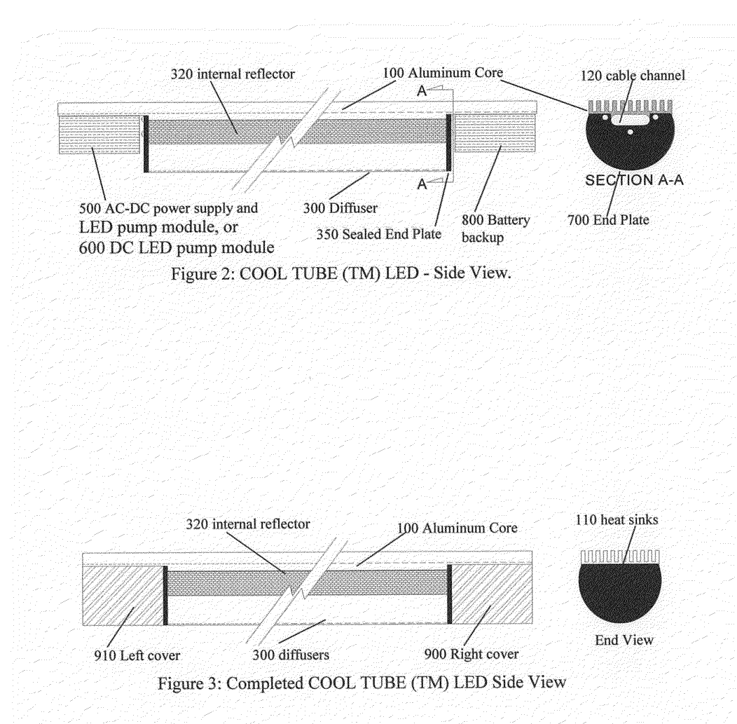

FIG. 2 illustrates the side view of the core 100 shown in FIG. 1. At one end of the core 100 and external to the diffuser 300 is the sealed AC-DC power converter and LED pump module 500, or optional DC LED pump module 600. The DC only LED pump module 600 may be used in installations to avoid running standard high voltage wiring between lights. The ends of the core 100 are sealed 350 by end plates 700. At the opposite end of the core 100 is an optional battery backup module 800.

FIG. 3 shows a side view of FIG. 2 with the end covers 900, 910 installed, providing a symmetrical look to the COOL TUBE™ LED.

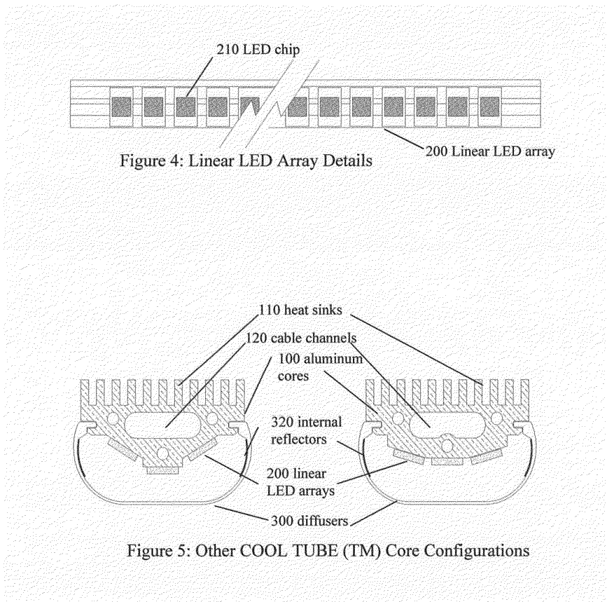

In the embodiment shown in FIG. 1, the light fixture includes three Light Emitting Diode (LED) linear arrays 200 attached to the core 100. FIG. 4 illustrates one of these linear arrays 200 made up of LED chips 210. Each LED chip 210 has a chip OEM advertised useful lifespan of at least 70,000 hours. The life expectancy of each linear LED array 200 may be extended by electronically configuring the array 200 circuitry using any of several methods to retain LED operating brightness in the event of one or more LED chip 210 failures. Such methods and circuitry are well known in the electrical arts. The number of LEDs in the linear array, per length of light tube and number of linear arrays in each light tube together with the LED Luminous flux and diffuser design are design parameters that can be tailored to produce an COOL TUBE™ LED that has the same, more or less brightness as a fluorescent fixture of the same size.

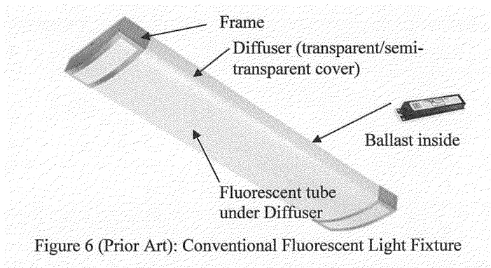

The COOL TUBE™ LED core 100 and attached diffuser 300 illustrated in FIG. 1 is only one of several possible embodiments of the basic core-diffuser concept. FIG. 5 illustrates several other configurations.

An extension of the sealed concepts illustrated in FIGS. 1 and 5 is to provide a weather tight but unsealed version wherein the LED linear arrays 200 are field replaceable as a module.

COOL TUBE™ LED technology of the present invention includes several major advantages compared with fluorescent tube fixtures, including, but not limited to: 1.) Increased Lifespan: Last greater than 70 time as long as the average fluorescent tube, which has even greater significance when cost of ownership is considered; 2.) Multiple Power Sources: The LED Cool Tube may he operated from typical. AC power, DC power source and from an on-board battery backup; 3.) Emergency Light Source: The LED Cool Tube will operate as emergency lighting with the onboard battery backup; 4.) Field Replaceable Electronics: The AC-DC power/LED pump and battery backup modules are all field replaceable; 5.) Lower Cost of ownership: A fraction of the fluorescent fixture cost when the fluorescent tube replacement cost over the years is factored in; 6.) Lower Heat output: Does not cause heat buildup under fixture. [Temperature can be up to 2 degrees warmer under fluorescent tubes]; 7.) Higher Efficiency: Lower electrical power cost to operate for same luminous flux; 8.) Higher Comfort Level: More ergonomic than fluorescent tubes. [Fluorescent tubes are not ergonomic: light is drab and all bulbs flicker (though not always visible to the human eye)]; 9.) No Hazardous Material: Fluorescent tubes contain mercury and must be disposed in hazardous material landfill; 10.) No Faculae (light or dark spots): LED light is well-distributed and more uniform from fixture; 11.) Improved Light fade: LEDs maintain rated luminous flux output for a longer period of their useful life (70,000+ hours); 12.) Re-lighting or location change is easy; a low voltage modular fixture containing the DC LED pump module simply replaces other ceiling tiles and plugs into dc power supply line, similar to low voltage garden lights; 13.) Improved shipping and storage: The LED fixture consumes less than ⅓ the volume of a comparable (same luminous flux) fluorescent fixture; 14.) Now possible to create mode lighting: LED fixture may he configured with different colored LEDS in the same assembly, thereby allowing color changes or color mixing by remote control; 15.) Dimming is easier: LED fixtures may be dimmed by simply adjusting, the drive current, remotely. Luminous flux is proportional to drive current. Typical or common fluorescent tubes cannot be dimmed; and, 16.) Sealed: The LED Cool Tube may be sealed permitting it to be used in wet, moist and potentially explosive locations.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A lighting fixture comprising an extruded core comprising a front panel light pipe and a plurality of light emitting diodes (LEDs) arranged in one or more lines on the light pipe and connected to a power supply, and a light diffuser attached to the core, the core further comprising an integrated heat sink.

2. The lighting fixture according to claim 1, further comprising end plates attached to the extruded core and wherein the extruded core is aluminum.

3. The lighting fixture according to claim 2, wherein the LEDs are coupled to the front panel light pipe by means of an internal light pipe.

4. The lighting fixture according to claim 3, wherein the light pipe is an integral part of the light diffuser.

5. The lighting fixture according to claim 2, wherein each LED further comprises a control circuit.

6. The lighting fixture according to claim 2, further comprising a backup battery power supply in communication with the LEDs.

7. The lighting fixture according to claim 2, wherein the light diffusor and end plates are attached to the core at a joint seal providing a watertight seal between the light diffuser and the core.

8. The lighting fixture according to claim 3, further comprising an external surface treatment on the light diffuser.

9. The lighting fixture according to claim 8, wherein the external surface treatment on the light diffuser is a prism light guiding plate in combination with an optical film.

10. The lighting fixture according to claim 8, wherein the external surface treatment on the light diffuser is micro lens embossing.

11. The lighting fixture according to claim 2, in which the light output produced during operation is the same as produced during operation of conventional fluorescent lighting fixtures.

12. The lighting fixture according to claim 2, in which the light output produced during operation is more than produced during operation of conventional fluorescent lighting fixtures.

13. The lighting fixture according to claim 2, in which the light output produced during operation is less than produced during operation of conventional fluorescent lighting fixtures.

14. The lighting fixture according to claim 11, wherein the lighting fixture is mountable in the place of a standard conventional fluorescent lighting fixture.

15. The lighting fixture according to claim 2, wherein the wavelength of light emitted during operation is white.

16. The lighting fixture according to claim 2, further comprising a color adjustment control in communication with the LEDs and wherein during operation the wavelength and intensity of light emitted can be changed.

17. The lighting fixture according to claim 6, wherein the power supply comprises a battery and the lighting fixture further includes a handle designed to allow it to he carried by a person.

18. The lighting fixture according to claim 2, wherein the fixture is designed for water submersion or underwater illumination.

19. The lighting fixture according to claim 2, wherein the fixture is designed as a backlight illumination source for an advertising panel.

20. A lighting fixture comprising an extruded aluminum core comprising a front panel light pipe and a plurality of light emitting diodes (LEDs) arranged in one or more lines on the light pipe and connected to a power supply, a light diffuser and end plates attached to the core at a joint seal, the core further comprising an integrated heat sink.
